(19) United States
(12) Patent Application Publication
(10) Pub. No.: US 2006/0166168 A1
(43) Pub. Date: Jul. 27, 2006

(54) Aesthetic endosteal implant

(76) Inventor: Carlo Tinti, Flero BS (IT)

Correspondence Address: LUCAS & MERCANTI, LLP, 475 PARK AVENUE SOUTH, 15TH FLOOR, NEW YORK, NY, 10016, US

(21) Appl. No.: 11/358,457

(22) Filed: Feb. 21, 2006

Related U.S. Application Data
(63) Continuation-in-part of application No. PCT/IB04/02916, filed on Sep. 8, 2004.

(30) Foreign Application Priority Data
Sep. 8, 2003 (IT) MI2003A 001720

(51) Int. Cl. A61C 8/00

(52) U.S. Cl. 433/173

(57) ABSTRACT

An endosteal implant comprising a screw (1), suitable for being inserted in the bone, provided in the frontal portion with a baseplate (3) and with a cavity (2), the latter being suitable for allowing the fixing of a prosthetic pillar (6, 6′) and for defining an external edge (10) and an internal edge (11) of the baseplate (3), said prosthetic pillar (6, 6′) being suitable for receiving a crown (9, 9′) for applying and shaping the tooth, a groove (4) being obtained on lateral surface of said baseplate (3), said crown (9, 9′) being provided with an extension (5), contiguous to its lateral surface and anguled with respect thereto, suitable for getting, with its complementary shape, into said groove (4), in such a way that the edges of the crown (9, 9′) correspond to the external edges of the baseplate (3).

### CROSS-REFERENCE TO RELATED APPLICATIONS

This application is a continuation-in-part of PCT International Application Serial No. PCT/IB2004/002916 filed Sep. 8, 2004, which, in turn, claimed the benefit of priority from Italian Patent Application No. MI2003A 001720 filed Sep. 8, 2003. The benefit of priority from each application is hereby claimed and the contents of each of which are incorporated herein by reference.

### BACKGROUND OF THE INVENTION

1. Field of the Invention

The present invention relates to an endosteal implant and to the relevant prosthetic components.

2. Art Relating to the Invention

It is known that many people turn to implantology for restoring the functionality of lost teeth. Osteointegrated implantology aims to provide a rigid bone anchorage for the prostheses in order to improve the mastication function.

Endosteal implants are substantially formed of a screw to be inserted in the bone and wherein a pillar is screwed. On the latter there is applied a crown (also known in the field as golden cylinder) which acts as a base for the tooth. Known implants may be divided in two groups according to whether the crown is screwed on the pillar or cemented thereto.

Both types of implants, though being functional from the osteointegration point of view, have the problem of being unaesthetic. As a matter of fact, when the teeth are extracted, the bone festoon-shaping which physiologically surrounds the dental elements is irremediably lost, therefore the bone where the implant is anchored assumes a substantially straight contour and the implants are arranged on a single axis. In this way the typical festooned contour of natural teeth is lost and the prosthetic result assumes an aesthetically unpleasant aspect.

This problem is more serious in the case of implants with angled pillars which are used to compensate improper arrangements of the same implants. In these cases, in fact, there is created an angle between the axis of the implant and the tooth which moves the edge of the tooth away from the gingival edge, making visible a part of the pillar and increasing thus the aesthetic problem.

In order to solve these problems, in the last years several solutions have been proposed which arrange the baseplate, the plate from which the tooth begins, underneath the gingival edge. However these solutions do not overcome the aesthetic problem caused by the loss of the festooned contour of the teeth.

The two U.S. Pat. Nos. 6,174,167 and No. 6,283,754 propose new types of endosteal implants which, although keeping the arrangement of the crown unchanged with respect to the prior art, imitate the festooned contour of the gum-cement junction of the natural tooth. However, in order to achieve this effect, they reduce significantly the thickness of the residual bone in the interproximal area, that is the area comprised between two teeth, making said bone not very vascularized and favoring thus the reabsorption thereof. Therefore, even if immediately after the completion of the implant the prosthetic result is aesthetically acceptable, it could become worse with the passing of time and have all the above mentioned aesthetical drawbacks.

Known implants of the screwed crown type, moreover, have the drawback of favoring the settlement of bacteria between the crown and the pillar with significant risks of inflammation of the tissues, in particular if the edge of the crown is placed under the gingival edge. On the other hand, known implants of the cemented crown type have problems when they have to be removed, for example for maintenance.

### SUMMARY OF THE INVENTION

The object of the present invention is therefore to provide an endosteal implant and the relevant prosthetic components free from said drawbacks.

Said object is achieved through an endosteal implant and relevant prosthetic components whose main features are specified in the first claim. Further features are specified in the subsequent claims.

The endosteal implant, according to the present invention, besides not having osteointegration surgical problems, is aesthetically pleasant since it preserves the festooned contour of the vestibular bone, that is the more external one with respect to the oral cavity, and thus it is imperceptible to the eye. Moreover this feature is more enduring with respect to the implants proposed up to now since the implant according to the present invention preserves as much bone as possible with consequent advantages for the health of the latter.

Another advantage of the endosteal implant according to the present invention is to provide the application of a thin layer of cement only on the edge of the baseplate in order to prevent the bacteria settlement and, at the same time, to favor a simple removal for maintenance.

Further advantages and features of the endosteal implant according to the present invention will be clear to those skilled in the art from the following detailed and non limiting description of some embodiments thereof with reference to the attached drawings.

### BRIEF DESCRIPTION OF THE DRAWINGS

FIG. 1 shows a see-through perspective view of the screw of the endosteal implant according to the first and to the second embodiment of the present invention;

FIG. 2 shows a see-through perspective view of some elements of the implant according to the first embodiment of the invention;

FIG. 3 shows a see-through perspective view of the implant according to the first embodiment of the present invention;

FIG. 4 shows a see-through perspective view of some elements of the implant according to the second embodiment of the present invention;

FIG. 5 shows a see-through perspective view of the implant according to the second embodiment of the present invention; and

FIG. 6 shows a see-through front view of the endosteal implant according to an alternative embodiment of the present invention.

### DETAILED DESCRIPTION OF THE INVENTION

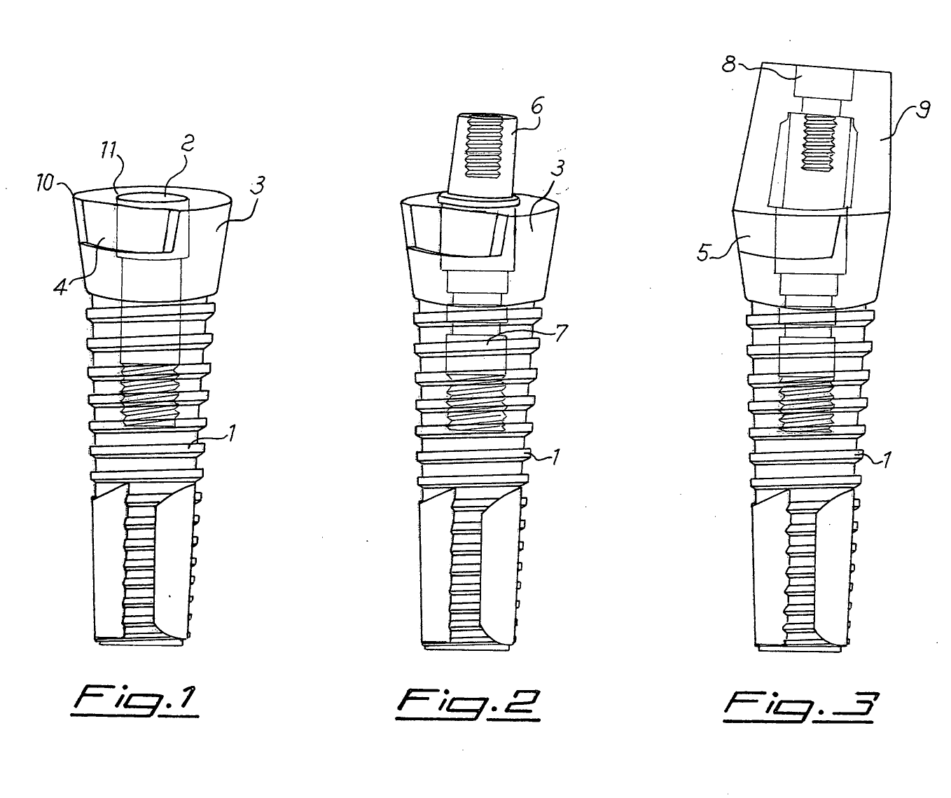

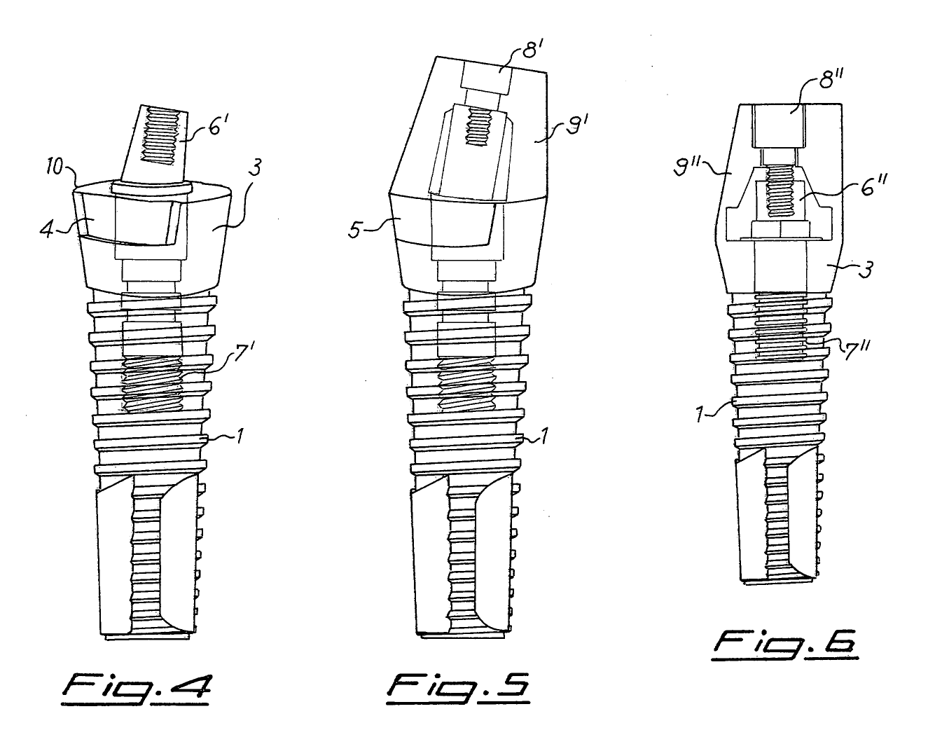

Referring to FIG. 1, there is seen that the implant according to the present invention comprises in a known way a screw 1 to be inserted in the bone and to act as anchorage for the prosthetic apparatus. This screw 1 has an internal cavity 2 fitted for receiving the shank 7, 7′ of a prosthetic pillar 6, 6′. This cavity 2 is preferably threaded in the bottom portion and has a preferably hexagonal section in a more external portion. It has the double function of allowing the insertion of a wrench for the positioning of the implant and of receiving the shank 7, 7′ of the prosthetic pillar 6, 6′, respectively shown in FIGS. 2 and 4. The screw 1 is further provided, in the top portion, that is on the end which protrudes externally, with a frusto-conically shaped baseplate 3 which comprises an internal edge 11 defining cavity 2 and an external edge 10. On the external surface of the baseplate 3 there is obtained a groove 4 of suitable shape and size.

Referring now also to FIGS. 2, 3, 4 and 5, there is seen that according to the present invention said prosthetic pillar 6, 6′ comprises a shank 7, 7′ suitable for being inserted in cavity 2 of screw 1 and a top projecting portion suitable for the anchorage of the crown. The prosthetic pillar 6, 6′ in the preferred embodiments, once it has been inserted in cavity 2, is fixed to screw 1 through cement or by screwing or fitting thereto by means of a hollow hexagonal element to improve and make steady the coupling.

The projecting portion of pillar 6, 6′ is substantially frusto-conically shaped with the major base laid on the baseplate 3 and ends on the internal edge 11 of the same baseplate 3. Said projecting portion of the prosthetic pillar 6, 6′ is provided with a threaded cavity wherein is screwed a further fastening means 8, 8′ fitted for fixing a crown 9, 9′ to the remainder of the implant. The crown 9, 9′ is substantially frusto-conically shaped and is provided with an extension 5, contiguous to the lateral surface thereof and anguled with respect thereto, suitable for getting, with its complementary shape, into groove 4 of the baseplate 3 in such a way that the edges of the crown 9, 9′ coincide with the external edges of the baseplate 3. The prosthetic pillar 6, 6′, once it has been mounted, forms with screw 1 an angle of width preferably comprised between 5° and 30°.

In the first embodiment, shown in FIGS. 2 and 3, the projecting portion of said prosthetic pillar 6 is frustoconical with an axis inclined of 5° with respect to screw 1. The fastening means 8 has the same inclination of said axis, while the shank 7 of the prosthetic pillar 6 is coaxial with screw 1. Obviously, the crown 9 has such a shape to fit the remaining prosthetic components 6, 8 and thus it is inclined of 5° too.

In the second embodiment, shown in FIGS. 4 and 5, the inclination of the projecting portion of the prosthetic pillar 6′, of the fastening means 8′ and of the crown 9′ is such to form an angle of about 22° with screw 1, while the further screw 7 is coaxial therewith.

FIG. 6 shows an implant with the prosthetic components 6″, 8″, 9″ coaxial with screw 1. In this case the shank 7″ of the prosthetic pillar 6″ is threaded as well as the inside of cavity 2 fitted for receiving it. The prosthetic pillar 6″ is thus fixed to screw 1 by simply screwing. As shown in FIG. 6, prosthetic pillar 6″ may be carried out in two connectable pieces, as for example a screw and a projecting portion connectable thereto. This implant, from an aesthetical point of view is similar to those of traditional type, but with respect thereto, it has the above mentioned advantages related to the maintenance and to the bacteria settlements.

The application of the implant according to the present invention takes place in the way described in the following.

Screw 1 is fixed in the bone in such a way to turn frontally the groove 4 of the baseplate 3. In this way, on the frontal aspect there is created the festooned bone structure typical of natural teeth, preserving most of the bone on the mesial, palatine and distal aspect of the implant, thanks to the peculiar shape and structure of the implant according to the present invention.

Once the screw 1 has been placed, shank 7, 7′ of the prosthetic pillar 6, 6′ has to be inserted in cavity 2. This prosthetic pillar 6, 6′ is fastened to screw 1 by means of a small quantity of cement.

After the tooth has been shaped on crown 9, 9′, there is applied a thin layer of cement or other binding materials only on the edge of the baseplate 3 and hence the crown 9, 9′ is positioned in such a way that the extension 5 gets into groove 4 and the edges of the crown 9, 9′ correspond to the external edge 10 of the baseplate 3. The crown 9, 9′ is then further fixed to the remaining prosthetic components through the fastening means 8, 8′. The exceeding cement is discharged partly outside, and thus removed, and partly inside the crown 9, 9′. However, thanks to the interspace between the prosthetic pillar 6, 6′, which lays on the internal edge 11 of the baseplate 3 and the crown 9, 9′ which lays on the external edge 10 of the baseplate 3, said exceeding cement does not spread on the prosthetic pillar 6, 6′ but is restrained in this interspace. Therefore, the retention of the cement is minimum, that is sufficient to avoid bacteria settlements but not so strong to cause problems during the maintenance. As a matter of fact, it is sufficient to apply a light force to remove crown 9, 9′ after the fastening means 8, 8′ has been unscrewed.

Since the edge of the tooth begins where crown 9, 9′ begins, that is on the external edge 10 of the baseplate 3, the bone and the gingival festooned contour is preserved for an indefinite period of time and the projecting outline of the teeth is aesthetically pleasant.

Obviously, the embodiments here described and illustrated are only non limiting examples of the invention. For example, in the preferred embodiments, the inclination of the implants are of about 5° and 22°, but in the same way may be carried out implants with different inclinations.

The dimension and the shape of groove 4 may be modified according to the requirements in order to preserve the maximum quantity of bone although ensuring the success of the implant.

Further variations and/or additions may be made by those skilled in the art to the embodiments here described and illustrated without departing from the scope of the invention itself.

For the construction of the implant according to the present invention it is possible to use any known material considered suitable for constructing implants of conventional type.

1. An endosteal implant comprising a screw (1), suitable for being inserted in the bone, provided in the frontal portion with a baseplate (3) and with a cavity (2), the latter being suitable for allowing the fixing of a prosthetic pillar (6, 6′) and for defining an external edge (10) and an internal edge (11) of the baseplate (3), said prosthetic pillar (6, 6′) being suitable for receiving a crown (9, 9′) for applying and shaping the tooth, characterized in that on lateral surface of said baseplate (3) is obtained a groove (4), said crown (9, 9′) being provided with an extension (5), contiguous to its lateral surface and angled with respect thereto, suitable for getting, with its complementary shape, into said groove (4), in such a way that the edges of the crown (9, 9′) correspond to the external edges of the baseplate (3), said prosthetic pillar (6, 6′) comprising a projecting portion which ends on said internal edge (11) and said crown (9, 9′) laying on said external edge (10), in such a way that between said prosthetic pillar and said crown (9, 9′) is kept an interspace for containing a binding material.

2. An endosteal implant according to claim 1, characterized in that the prosthetic pillar (6, 6′) is fastened to the screw (1) by means of cement.

3. An endosteal implant according to one of the previous claims, characterized in that the projecting portion of said prosthetic pillar (6, 6′) is provided with a threaded cavity wherein a fastening means (8, 8′), suitable for fixing said crown (9, 9′), is screwable.

4. An endosteal implant according to claim 3, characterized in that the projecting portion of the prosthetic pillar (6, 6′), the fastening means (8, 8′) and the crown (9, 9′) are inclined with respect to the axis of the screw (1).

5. An endosteal implant according to claim 4, characterized in that the angle formed by the projecting portion of the prosthetic pillar (6, 6′), by the fastening means (8, 8′) and by the crown (9, 9′) with the axis of the screw (1) is preferably comprised between 5° and 30°.

6. An endosteal implant according to claim 5, characterized in that said angle formed by the projecting portion of the prosthetic pillar (6), by the fastening means (8) and by the crown (9) with the axis of the screw (1) is of 5°.

7. An endosteal implant according to claim 5, characterized in that said angle formed by the projecting portion of the prosthetic pillar (6′), by the fastening means (8′) and by the crown (9′) with the axis of the screw (1) is of 22°.

8. An endosteal implant according to one of the previous claims from 1 to 3, characterized in that the prosthetic pillar (6″), the further screw (7″), the fastening means (8″) and the crown (9″) are coaxial with the screw (1).

9. An endosteal implant according to one of the previous claims, characterized in that a binding material is applied on the baseplate (3) before the application of the crown (9, 9′, 9″).
